(19) United States
(12) Patent Application Publication
(10) Pub. No.: US 2021/0012606 A1
(43) Pub. Date: Jan. 14, 2021

(54) FOOD PRODUCT STORAGE AND VENDING KIOSK

(71) Applicant: COMMERCIAL AUTOMATION, LLC, Lansing, KS (US)

(72) Inventors: Beverly A. BARNUM, Irvine, CA (US); Adrian M. ABORDO, Oceanside, CA (US); Ryan Michael RODRIGUEZ, Rancho Santa Margarita, CA (US); Michael Jay DOBIE, Lewisville, TX (US); Neal S. COOPER, N. Richland Hills, TX (US)

(21) Appl. No.: 17/034,516

(22) Filed: Sep. 28, 2020

Related U.S. Application Data
(63) Continuation-in-part of application No. 16/184,563, filed on Nov. 8, 2018, now Pat. No. 10,818,123.
(60) Provisional application No. 62/583,123, filed on Nov. 8, 2017.

(51) Int. Cl. G07F 11/72; G06Q 20/18; F25D 13/04

(52) U.S. Cl. CPC G07F 11/72; F25D 13/04; G06Q 20/18

(57) ABSTRACT

A food product storage and vending kiosk includes a cold storage unit, an oven unit, and a transportation mechanism. The cold storage unit includes a plurality of food packages, an active shelving system storing the plurality of food packages, and a freezer. Each of the food packages includes a food product in a box. The oven unit includes a base oven deck for receiving the food product and rising to meet and seal with a main body to form a sealed oven cavity for cooking the food product. The transportation mechanism is for moving a food package out of the cold storage unit, onto an elevator platform that lifts the food package to the oven unit, pushing the food product from the box onto the base oven deck for cooking, and pushing the food product off of the base oven deck into the box and out of a delivery chute.

### CROSS-REFERENCE TO RELATED APPLICATIONS

This application is a continuation-in-part of U.S. patent application Ser. No. 16/184,563, filed Nov. 8, 2018, which claims the benefit of U.S. Provisional Patent Application No. 62/583,123, filed Nov. 8, 2017, the entire disclosures of which are hereby incorporated by reference.

### BACKGROUND OF THE INVENTION

### 1. Field of the Invention

The present invention pertains to the field of vending machines (kiosks). In particular, the invention relates to a food product storage and vending kiosk with a cold storage unit, a rapid-cook (non-microwave) oven unit, and a transportation mechanism for moving a food product from the storage unit to the oven unit to a customer.

### 2. Background Art

A problem that has been identified is how to safely store and rapidly cook a food product and dispense the cooked food product to a consumer in a stand-alone kiosk. Other available machines do not have this unique set of capabilities that is scalable to mass production. There are vending machines that distribute food to consumers following a transaction, whereby the consumer can select from a variety of offerings. Some kiosks can vend hot food. Such vending machines typically include a cooling container to store food, an oven for cooking, a mechanism to transport food between the cooler and oven, and a mechanism to dispense the food to the consumer. A majority of the kiosks utilize refrigerators sustaining only limited shelf life for perishable food products. Additionally, the ovens for most of the kiosks use microwave technology to provide rapid cooking (i.e. a “speed oven”). Throughout speed oven development, microwave heating has been added to most concepts for cooking speed, but during the process it distorts the food product and typically yields a “rubbery” finished product. Furthermore, the other available machines have a an overall dispense time (comprised of pre-heating, plus cook time) that is too long, so customers get impatient and choose not to use the machine. This is partially due to the vast majority of vending machine ovens opening from the front or side, which allows substantial amounts of heat to dissipate, minimizing the oven's ability to rapidly cook in sequence.

### BRIEF SUMMARY OF THE INVENTION

The invention is a self-contained automated food product storage and vending machine (i.e., kiosk) whereby packaged food products like pizza are stored inside a freezer/refrigeration unit (i.e., a cold storage unit). The kiosk includes: the freezer/refrigeration unit, a transportation mechanism, and an oven unit, as described in more detail below.

The freezer/refrigeration unit holds a plurality of columns of packed foodstuff, supported by rigid braces and subsequently transported to an adjacent oven unit, where the food is heated prior to its delivery to a customer. The active shelving allows for the discrete dispensing of an individual food item from one of the columns. In order to facilitate replenishment of the packaged food products as well as for cleaning, the shelving columns are top-mounted on telescopic rails, which allow a single shelving column at a time to be pulled out of the machine for access.

In one embodiment, the package is a box which is pre-folded to form a three-sided tray. The package is used as a shelf for cold storage and to transport the foodstuff to the oven. The foodstuff is removed from the tray for cooking, and upon completion of cooking, the pizza is returned to the tray for delivery to the customer, who can manually release the flap and rotate the lid over to securely close the box for transport.

The transportation mechanism for moving the pizza out of the box and back into the box following heating utilizes a pushing element “wrangler′ device. This shepherding device is able to guide transfer of the pizza out of the box and onto the deck of the oven. Upon completion, the back-side of the wrangler (which may or may not be the front face); with an attached optional scraper to clear the oven surface, will steer the hot pizza off the hot oven deck and onto the un-heated box.

The kiosk contains an oven for the preparation of the pizza which utilizes multiple cooking methods (comprised of at least one heating element and at least one air circulation element) and ventless operation within a single oven compartment. The specialized “rapid cook” unit features three fundamental heat transfer methods: [heated air-circulation] forced convection air impingement, [Infrared] radiation and [deck] conduction, NOT using microwave technology. The combination leads to faster preparation of the pizza. The oven unit is equipped with a catalytic converter on the exhaust, which breaks down grease-laden vapors and smoke for ventless operation. Furthermore, the oven is opened by lowering the bottom part relative to the top part. This open-side down design helps to retain heat within the oven even during the insertion and removal of the pizza to/from the oven.

The kiosk may also include a mechanism in the freezer having a hatch cover formed with an insulating material and slotted guides constrained on both sides. The hatch cover is prevented from canting by guides on each side. The hatch cover is attached fixedly to the shaft of a motor. When the motor is actuated linearly, it lifts the door, the door slides open in a mostly vertical fashion. The door is fully closed at the bottom position. In the case of a power failure, gravity will maintain the hatch door in the closed and sealed position.

Accordingly, in one aspect of the invention, a food product storage and vending kiosk includes a cold storage unit, an oven unit, and a transportation mechanism. The cold storage unit includes a plurality of food packages, an active shelving system storing the plurality of food packages, and a refrigerator for maintaining an interior of the cold storage unit at a predetermined temperature. Each of the food packages includes a food product in a box. The oven unit includes a base oven deck for receiving the food product and rising to meet and seal with a main body to form a sealed oven cavity for cooking the food product. The transportation mechanism is for moving a food package out of the cold storage unit, onto an elevator platform that lifts the food package to the oven unit, pushing the food product from the box onto the base oven deck for cooking, and pushing the food product off of the base oven deck into the box and pushing the re-packaged food out of a delivery chute of the kiosk after cooking.

In one implementation, the box of each of the plurality of food packages has an open top and an open front forming a three-sided tray containing the food product, and the active shelving system includes a plurality of columns of shelf elements supporting and dispensing the plurality of food packages.

Each of the plurality of columns of shelf elements may include two parallel Archimedes screws and screw actuators. An outer diameter and pitch of each of the Archimedes screws is configured such that one of the plurality of food packages is capable of being supported between threads of each of the screws and synchronized rotation of the Archimedes screws by the screw actuators lowers the column until a food package drops free of the column.

Alternatively, each of the plurality of columns of shelf elements may include two parallel vertical conveyor belts and belt actuators. Cleats attached to each of the conveyor belts are configured such that one of the plurality of food packages is capable of being supported between cleats of each of the conveyor belts and such that synchronized movement of the conveyor belts lowers the column until a food package drops free of the column.

In another implementation, each of the columns of shelf elements is mounted on a telescopic rail which allows the respective column of shelf elements to be pulled out by machine maintenance personnel for access to clean or replenishment of food packages.

In yet another implementation, the base oven deck includes a heated platen that comes in direct contact with the food product, and the main body includes at least one circular radiant element, a plenum on both sides of the oven cavity, a motor-driven fan on top of the main body that pressurizes the plenum, a return opening to the motor driven fan, a return duct from the oven cavity to the return opening, open coil heaters in the return duct, and impingement jets fed by the plenum. The circular radiant element(s) is (are) in a center area of the oven cavity. The impingement jets deliver heated air to exposed surfaces of the food product. Thus, that the oven unit includes impingement, radiation, and conduction heat transfer methods.

The main body of the oven unit may further include a vent open to the plenum for exhaust from the oven unit, and an electrically heated catalyst in the vent to remove hydrocarbons in the exhaust.

In still yet another implementation, the cold storage unit defines a hatch between an interior of the cold storage unit and an oven compartment wherein the oven unit is located, and includes a motorized hatch cover over the hatch. Then, the transportation mechanism includes a storage unit conveyor below the active shelving system and an oven-side conveyor in alignment with the hatch. The storage unit conveyor and the oven-side conveyor are for transporting a food package from the storage unit, through the hatch, and into the oven compartment.

In another aspect of the invention, a food product storage and vending kiosk includes a cold storage unit, an oven unit, and a transportation mechanism. The cold storage unit includes a plurality of food packages, each of the plurality of food packages includes a food product in a box. The oven unit includes a main body having an open bottom side oriented down and a base oven deck for receiving the food product and rising to meet and seal with the main body to form a sealed oven cavity for cooking the food product. The transportation mechanism includes an oven-side conveyor, an elevator platform, and a sweeper arm assembly. The elevator platform and the sweeper arm assembly are positioned at opposite sides of the oven-side conveyor. The sweeper arm assembly includes a stopper bar oriented perpendicular to a direction of travel of the oven-side conveyor, a sweeper bar oriented parallel with the direction of travel of the oven-side conveyor, and a sweeper actuator for causing the sweeper bar to sweep the food package off the oven-side conveyor and onto the elevator platform. The transportation mechanism is for moving a food package out of the cold storage unit and onto the elevator platform that lifts the food package to the oven unit, pushing the food product from the box directly onto the base oven deck for cooking, and pushing the food product off of the base oven deck into the box and out of the delivery chute after cooking.

The transportation mechanism may further include a pair of box retention fingers and a wrangler assembly. The box retention fingers engage the box of the food package when the elevator platform has lifted the food package to the oven unit. The wrangler assembly includes a front-side member, a back-side member, and a loading/unloading actuator, the loading/unloading actuator for causing the front-side member to push the food product out the open front of the box onto the base oven deck before cooking and for causing the back-side member to push the food product from the base oven deck back into the box after cooking, and then, after retraction of the box retention fingers, pushing the food product and box out through the delivery chute.

The wrangler assembly may further include a motorized lifting module for raising the front-side member and back-side member of the wrangler assembly enough to clear the food product as the loading/unloading actuator moves back to the elevator platform after pushing the food product onto the base oven deck before cooking and back to the base oven deck before pushing the food product back into the box after cooking.

Additionally, the back-side member of the wrangler may further include a scraper to scrape crumbs off a surface of the base oven deck into a gap defined between the base oven deck and the box as the loading/unloading actuator causes the back-side member of the wrangler assembly to push the food product from the base oven deck back into the box after cooking.

According to yet another aspect of the invention, an oven unit includes a main body and a base oven deck defining an oven cavity. The main body has an open bottom. The base oven deck is for receiving a food product and rising to meet and seal with the main body for cooking the food product in the oven cavity, the main body being opened by lowering the base oven deck relative to the main body. The main body includes radiant elements directly over the oven cavity for providing radiant heating to the food product, and impingement jets on respective sides of the oven cavity for providing convection heating the food product. The base oven deck includes a heated platen for providing conductive heating to a bottom of the food product.

In one implementation, the main body further includes a reflective surface above the radiant elements, the reflective surface increasing radiant heating efficiency by reflecting radiant energy downward toward the food product.

In another implementation, the main body further includes: a motor-driven fan in a top portion of the main body; a plenum on both sides of the oven cavity between the motor-driven fan and the impingement jets; a return duct between the oven cavity and the motor-driven fan; and heaters located in the return duct. The heaters produce heated air in the return duct, the motor-driven fan pressurizes the plenum with the heated air, and the plenum feeds the impingement jets, and the impingement jets deliver heated air to exposed surfaces of the food product.

In yet another implementation, the main body further includes a vent between the plenum and an exterior of the main body. The vent includes a catalytic converter for removing hydrocarbons before they exit the oven unit, allowing ventless operation of the oven unit in an indoor environment.

In still yet another implementation, the heated platen is heated by an electric heater, and the heated platen is a glass ceramic material, both transmitting thermal radiation and absorbing thermal radiation, such that the bottom of the food product is heated by both radiation and conduction.

### BRIEF DESCRIPTION OF THE SEVERAL VIEWS OF THE DRAWINGS

These and other features, aspects, and advantages of the present invention will become better understood with regard to the following description, appended claims, and accompanying drawings where:

FIG. 1 is a perspective view of an exemplary vending machine (kiosk) according to the invention;

FIG. 2 is a perspective view of the vending machine of FIG. 1 without front service doors, showing components within the interior of the vending machine;

FIG. 3 is a perspective view of a single stack of an exemplary auger-type system;

FIG. 4 is a partial perspective view of the single stack of the auger-type system;

FIG. 5 is a partial perspective view of the single stack of the auger-type system;

FIG. 6 is a perspective view of a single stack of an exemplary conveyor-type system;

FIG. 7 is a partial front view of the single stack of the conveyor-type system;

FIG. 8 is partial perspective view of the single stack of the conveyor-type system;

FIG. 9 is a perspective view of the auger-type system with three storage shelving columns;

FIG. 10 is a front view of the conveyor-type system with three storage shelving columns;

FIG. 11 is a perspective view of the conveyor-type system with a middle column in a ‘loading’ position;

FIG. 12 is a perspective view of a storage unit and a transportation mechanism according to an exemplary embodiment of the invention, with selected elements hidden for clarity;

FIG. 13 is another perspective view of the storage unit and transportation mechanism of FIG. 12;

FIG. 14 is another perspective view of the storage unit and transportation mechanism of FIG. 12, with selected elements hidden for clarity;

FIG. 15 is another perspective view of the storage unit and transportation mechanism of FIG. 12, with selected elements hidden for clarity;

FIG. 16A is a side view of an exemplary transfer hatch and cover.

FIG. 16B is a perspective view of the transfer hatch and cover of FIG. 16A.

FIG. 17 is another perspective view of the storage unit and transportation mechanism of FIG. 12, with selected elements hidden for clarity, showing a sweeping actuator and elevator platform in the loading position;

FIG. 18A is a partial perspective view of the exemplary transportation mechanism, with selected elements hidden for clarity, showing the exemplary sweeping actuator and elevator platform of FIG. 17, with a box/pizza in the process of being transferred from the oven-side conveyor to the elevator platform;

FIG. 18B is a partial perspective view of the exemplary sweeping actuator and elevator platform of FIG. 18A, with the box/pizza on the elevator platform and the sweeping actuator retracted;

FIG. 19A is a partial perspective view of the transportation mechanism and an oven unit according to the exemplary embodiment of the invention, with selected elements hidden for clarity, showing the exemplary elevator in a position at mid-path;

FIG. 19B is a partial perspective view of the exemplary elevator of FIG. 19A in an upper position;

FIG. 20 is another partial perspective view of the transportation mechanism and oven unit, with selected elements hidden for clarity, showing a pair of exemplary box retention fingers engaging the box on the elevator platform;

FIG. 21 is a partial perspective of the exemplary vending machine, with selected elements hidden for clarity, showing an exemplary loading end-effector (“wrangler”) engaged with the pizza;

FIG. 22 is another partial perspective view of the transportation mechanism and the oven unit, with selected elements hidden for clarity, showing the exemplary loading end-effector (“wrangler”);

FIG. 23 is another partial perspective view of the transportation mechanism and the oven unit, with selected elements hidden for clarity, showing the oven unit with the base lowered to the open/loading position and the wrangler in the process of transferring the pizza to the oven unit;

FIG. 24 is another partial perspective view of the transportation mechanism and the oven unit, with selected elements hidden for clarity, showing the oven unit with the base lowered to the open/loading position and the wrangler in the process of transferring the pizza to the oven unit;

FIG. 25A is another partial perspective view of the transportation mechanism and the oven unit, with selected elements hidden for clarity, showing an exemplary wrangler with a lifting actuator;

FIG. 25B is another partial perspective view of the exemplary wrangler with a lifting actuator of FIG. 25A;

FIG. 26A-26D are other partial perspective views of the transportation mechanism and the oven unit, with selected elements hidden for clarity, showing the wrangler in the process of transferring the pizza to and from the oven, and preparing to dispense the box/pizza;

FIG. 27 is another partial perspective views of the transportation mechanism and the oven unit, with selected elements hidden for clarity, showing an exemplary ‘scraper’ attachment acting on an oven platen surface as the wrangler pushes the pizza into the tray;

FIG. 28A is a front view of the oven unit showing the bottom raised to a closed/cooking position;

FIG. 28B is a front view of the oven unit showing the bottom lowered to an open/loading position;

FIG. 29 is a cross-section of the oven unit;

FIG. 30 is a partial perspective view of the oven unit showing a front-back slice of the oven unit; and

FIG. 31 is a partial perspective view of the oven unit showing a left-right slice of the oven unit.

### DETAILED DESCRIPTION OF EXEMPLARY EMBODIMENTS OF THE INVENTION

The details of one or more embodiments of the presently-disclosed subject matter are set forth below and in attachments to this document. Modifications to embodiments described below and in the attachments, and other embodiments, will be evident to those of ordinary skill in the art after a study of the information provided in these attachments. The information provided in these attachments, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by one of ordinary skill in the art, definitions are set forth herein to facilitate explanation of the presently-disclosed subject matter.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a,” “an,” and “the” refer to “one or more” when used in this application, including the claims/sample claims.

Throughout this description, the term “actuator” will be used to indicate an apparatus that imparts a desired mechanical motion to another component; it is a “mover”.

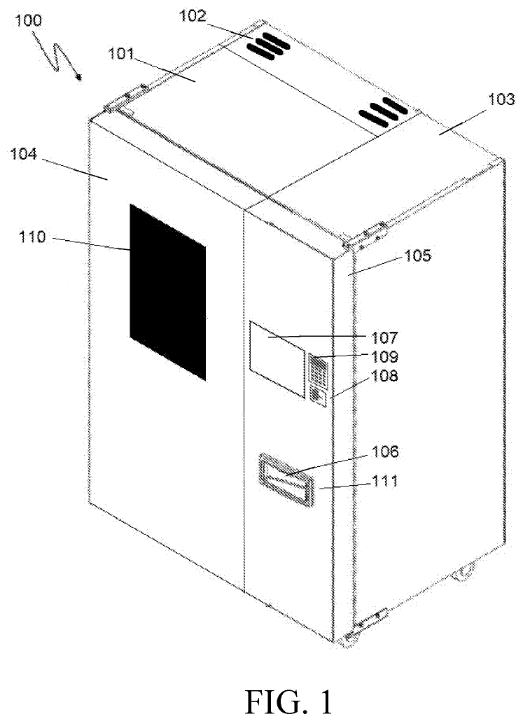

FIG. 1 shows an exemplary food product storage and vending kiosk 100. For the sake of clarity, vending kiosk 100 is illustrated without interior machinery. Vending kiosk 100 includes a cold storage unit 101 which is preferably a freezer cooled by refrigeration equipment (including a compressor/condenser, evaporators fans, filters, and tubing) housed in a refrigeration equipment unit 102, an oven compartment 103 housing additional components, including a rapid cook oven described below, and service doors 104, 105.

The refrigeration equipment unit 102 includes refrigeration equipment (e.g., a freezer) for maintaining the interior of the cold storage unit 101 at a predetermined temperature. Such refrigeration equipment is known in the art and will not be described in detail here. In one embodiment, the predetermined temperature is below freezing in order to extend the shelf life of the food products stored therein.

Service door 104 may include an optional Digital Signage screen 110. Service door 105 may include a convex-shaped section adjacent to a flat service door; however, this shape is not necessary for the invention and is not illustrated here. Service doors 104, 105 may be lighted with decorative LED lights or contain other graphical or attractive elements. A delivery chute 106 is located in service door 105 such that food products can be discharged from vending kiosk 100. A tamper barrier 111 helps prevent tampering with the interior of the vending kiosk via the delivery chute.

Various user interface features are on service door 105. A touchscreen display 107 is used for a customer to select and to display various information. The touchscreen display 107 can be used to both present menu options to the user and to accept responses from the customer. A multi-function card reader 108 accepts payment in cooperation with a PIN pad 109.

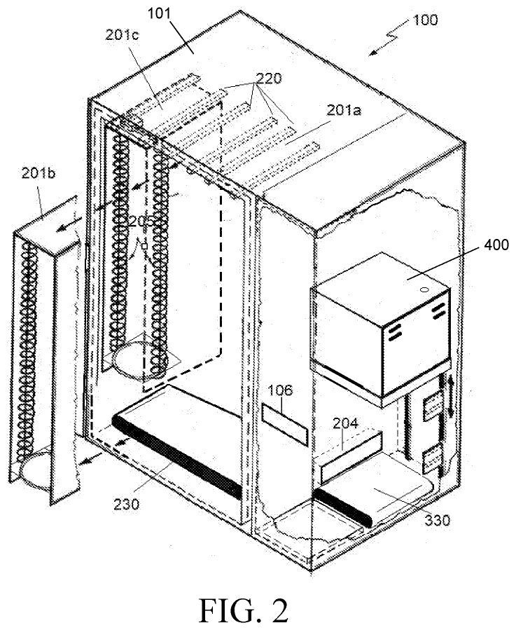

FIG. 2 is a perspective view of the vending kiosk 100 without the service doors 104, 105, showing components within the interior of vending kiosk 100. Some portions of vending kiosk 100 are cut away to better illustrated components within. The interior of vending kiosk 100 includes, among other components discussed below, the cold storage unit 101, with the food products/boxes (i.e., food-containing packages) stored vertically in a plurality of columns (201a, 201b, 201c) comprising an active shelving system. The active shelving system allows for storage of food products/boxes (i.e., packaged food, such as frozen pizza) in a space-efficient manner and avoids a storage area where the packages at the bottom of the column are crushed from the weight of the packages stacked above. In one embodiment, each box has an open top and an open front; the box is folded such that it results in a 3-sided tray.

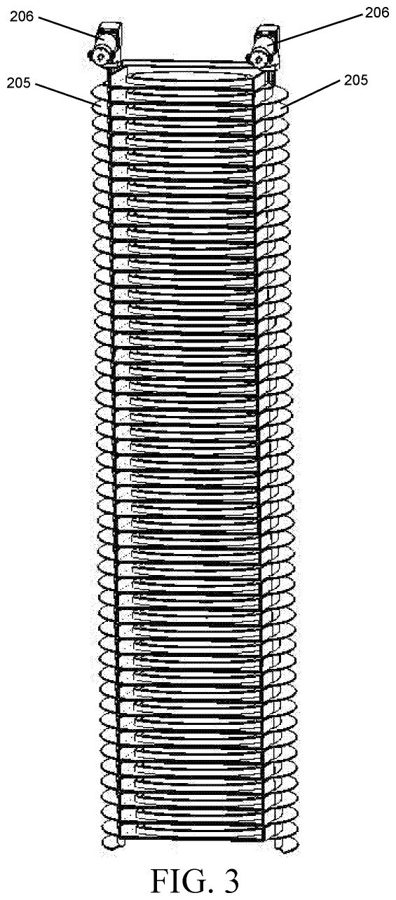

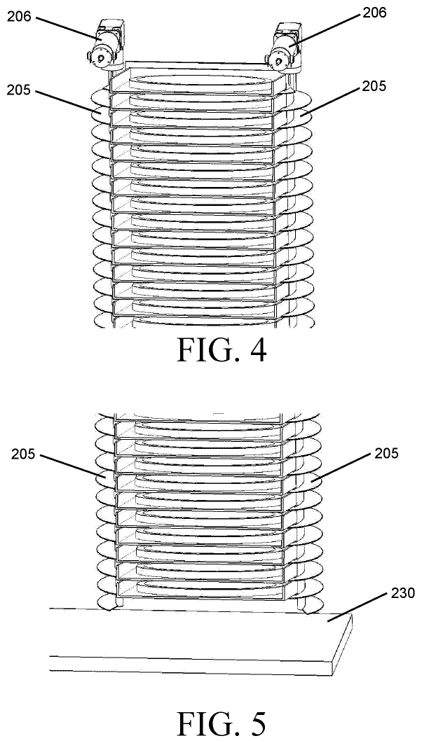

FIG. 3, FIG. 4, and FIG. 5 show food products/boxes supported in an exemplary auger-type system, wherein a column of food products/boxes is supported between two parallel Archimedes screws 205. Screw actuators 206 turn the screws 205 to cause a food product/box to drop onto a storage unit conveyor 230.

Returning to FIG. 2, the vertical conveyors are mounted to a pair of horizontal guides 220 affixed to a plate that slides out of the cold storage unit 101. This enables loading of the columns (201a, 201b, 201c) with pizzas on trays. FIG. 2 shows an auger-style storage system with the middle column 201b in the slide-out position. The storage unit conveyor 230 moves the food product/box from below the vertical column through a storage unit (e.g., freezer) opening 204 which is covered by an insulated hatch (not shown for clarity). An oven-side conveyor 330 completes the transfer of the food product/box out of the cold storage unit 101 (i.e., freezer). A transportation mechanism, described below, moves the food product/box from the oven-side conveyor 330 to an oven unit 400 and finally to a customer through the delivery chute 106.

FIG. 3, FIG. 4 and FIG. 5 show the exemplary auger-type system. The outer diameter and pitch of the screws 205 are designed so that a food product/box (i.e., food package) is supported between each thread. Synchronized rotation of the screw 205 lowers the entire column of food products/boxes (i.e., food packages) until an individual food product/box (i.e., food package) drops free of the screws 205 onto the storage unit conveyor 230.

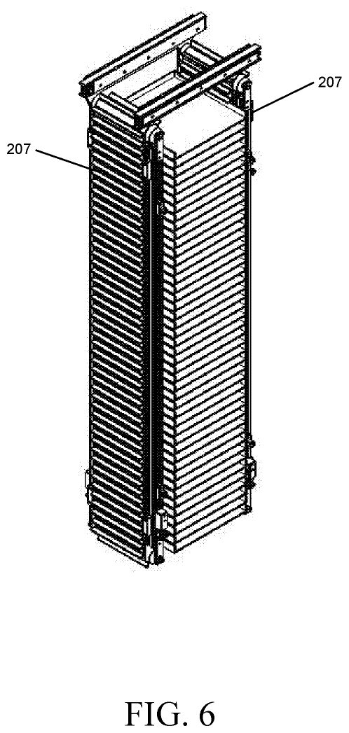

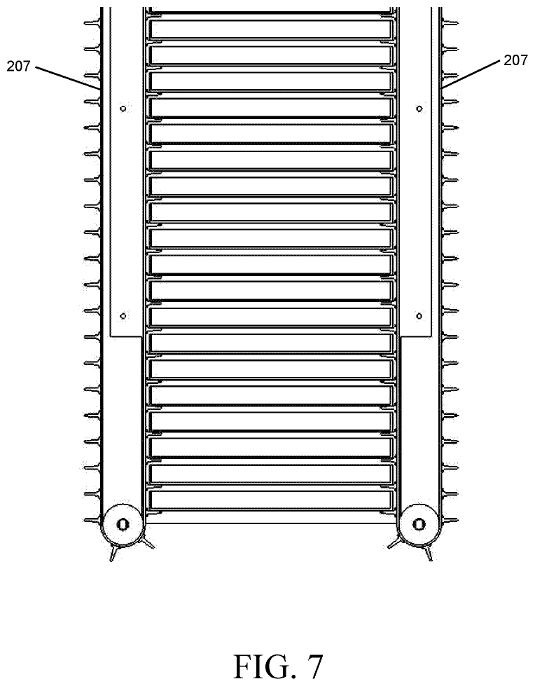

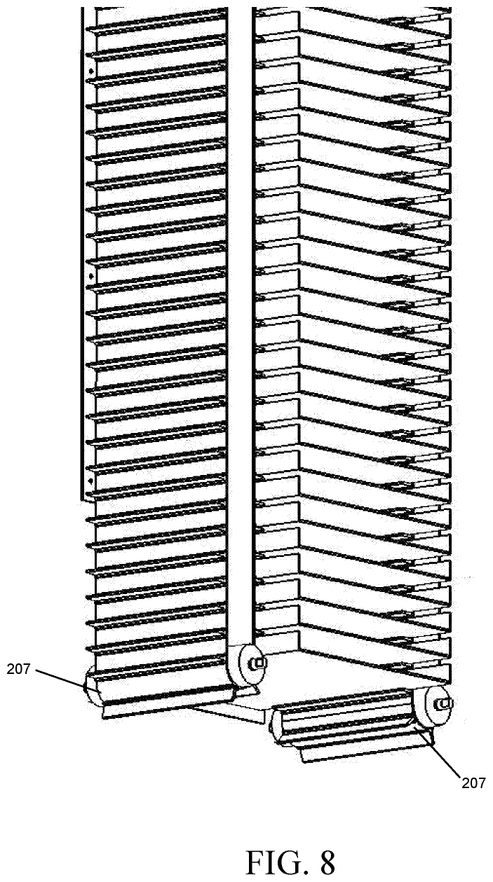

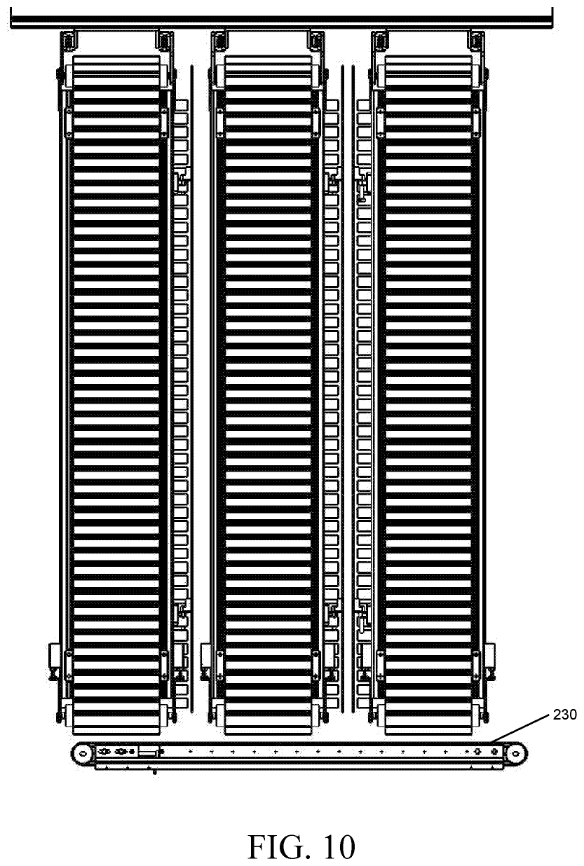

FIG. 6, FIG. 7, and FIG. 8 show an exemplary conveyor-type system wherein a stack of food products/boxes (i.e., packaged foods) is supported between two parallel vertical conveyor belts 207. Cleats attached to the conveyor belts function as support elements. Synchronized movement of the conveyor belts 207 lowers the entire column of food products/boxes (i.e., packaged food) until an individual food product/box drops free of the conveyor belts 207 onto the storage unit conveyor 230 (see FIG. 10).

For both conveyor and auger type systems, multiple shelving columns are arrayed to increase storage capacity and to provide multiple varieties of food products. Each column holds a single food product type (e.g., a pizza type), and the number of shelving columns is directly correlated with the number of selectable varieties.

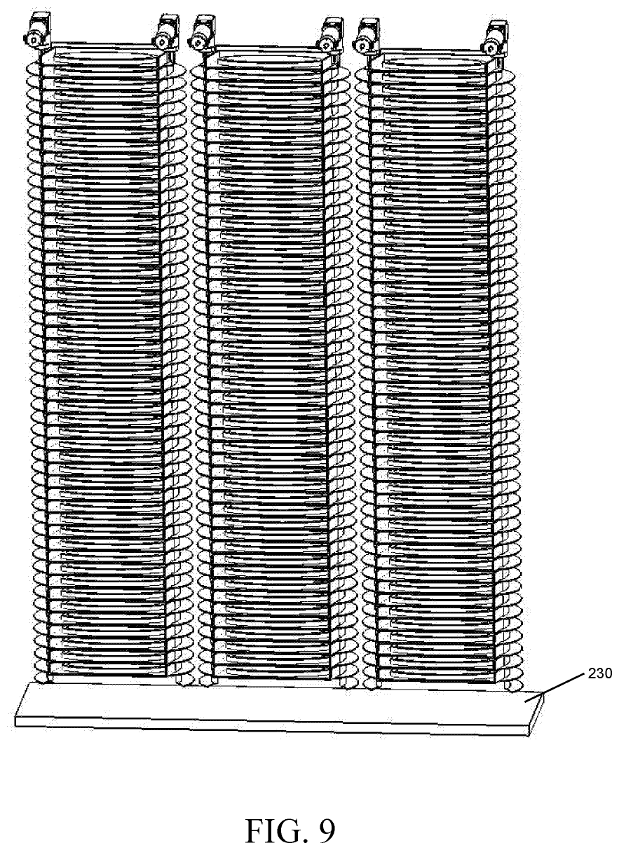

FIG. 9 shows an exemplary auger-type system with multiple shelving columns.

FIG. 10 shows an exemplary conveyor-type system with multiple shelving columns.

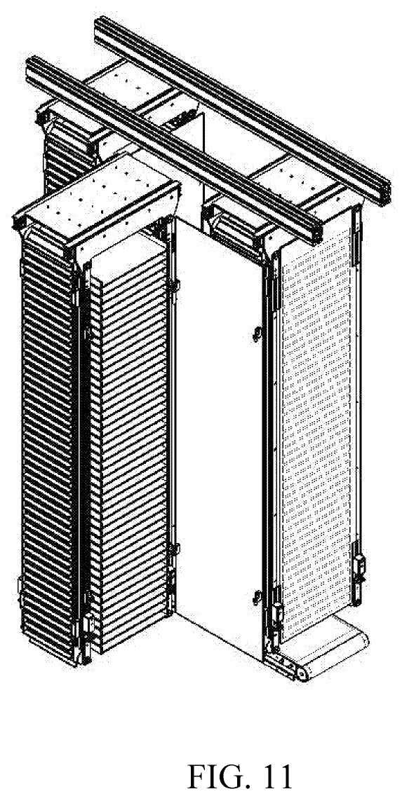

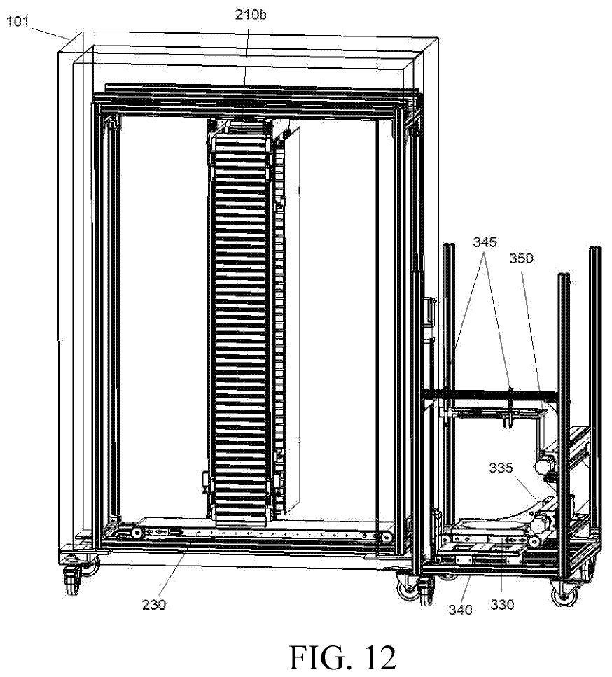

FIG. 11 and FIG. 12 are perspective views of an exemplary conveyor-type system wherein the shelving columns are very closely spaced in order to minimize the footprint of the food product storage and vending kiosk. In order to facilitate easy replenishment of the food products/boxes, the shelving columns are mounted on telescopic rails which allow an individual shelving column to be pulled out by machine maintenance personnel. Once a shelving column has been pulled out, the maintainer has access to the sides of each column, through which they can remove or replenish food products/boxes. Although a conveyor-type system is shown, one of skill in the art will understand that this telescoping feature may also be used with auger-type systems as well.

Referring again to FIG. 2, the transportation mechanism is responsible for moving the food product/box from the cold storage unit 101 to the oven unit 400 for cooking, and delivery to a customer.

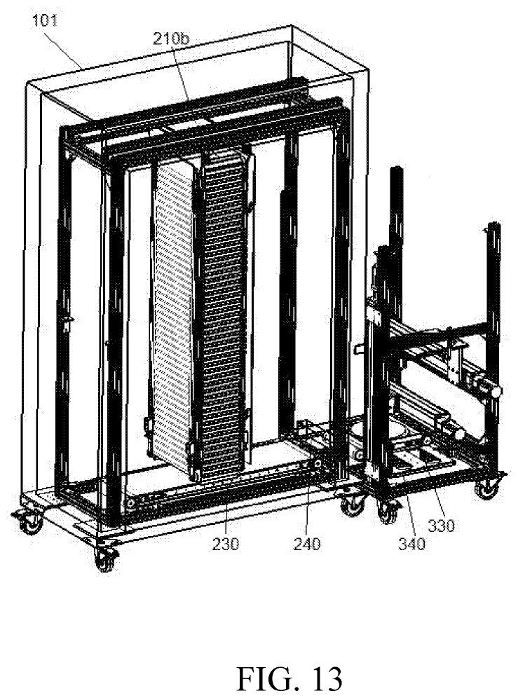

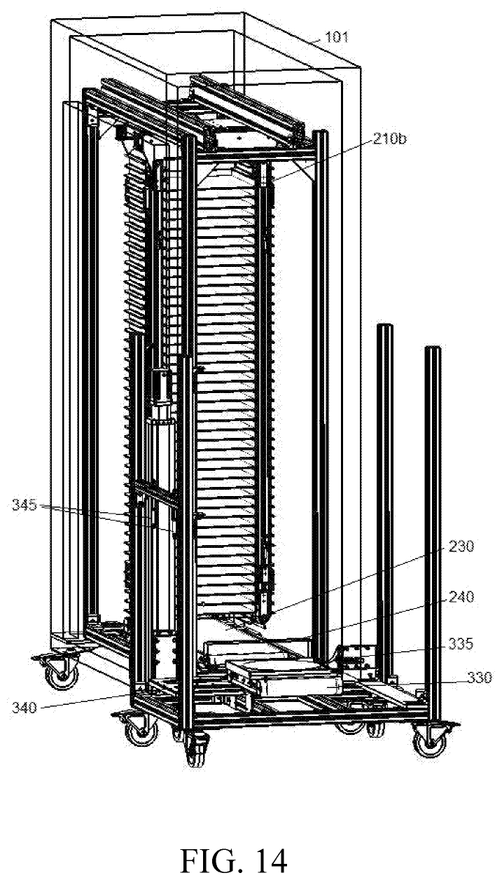

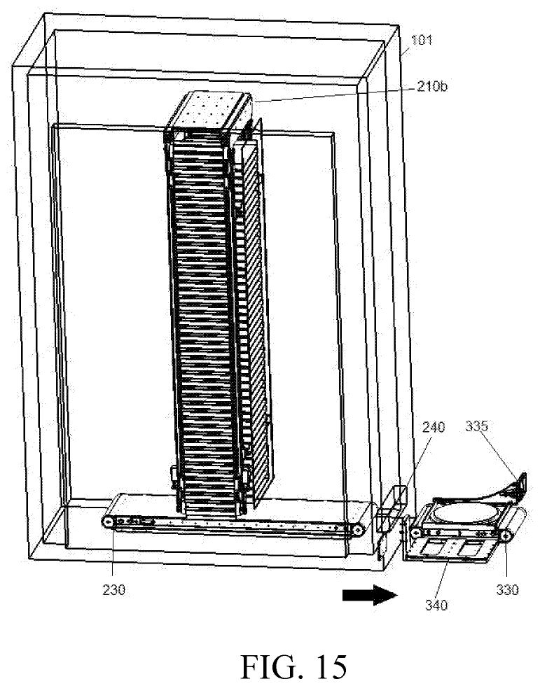

FIG. 13, FIG. 14, and FIG. 15 are partial perspective views of the exemplary transportation mechanism, with the storage unit conveyor 230 for moving a food product/box out of the cold storage unit 101. Shown is an outline of the cold storage unit 101, with the middle stack 210b of a conveyor-type system. Below the middle stack 210b is the storage unit conveyor 230, which transports the food product/box from a column, through a hatch 240, and to the oven-side conveyor 330. A sweeper arm assembly 335 aligns the food product/box on the conveyor. An elevator platform 340 positioned at its low position is shown. Also shown are box retention fingers 345, discussed further below.

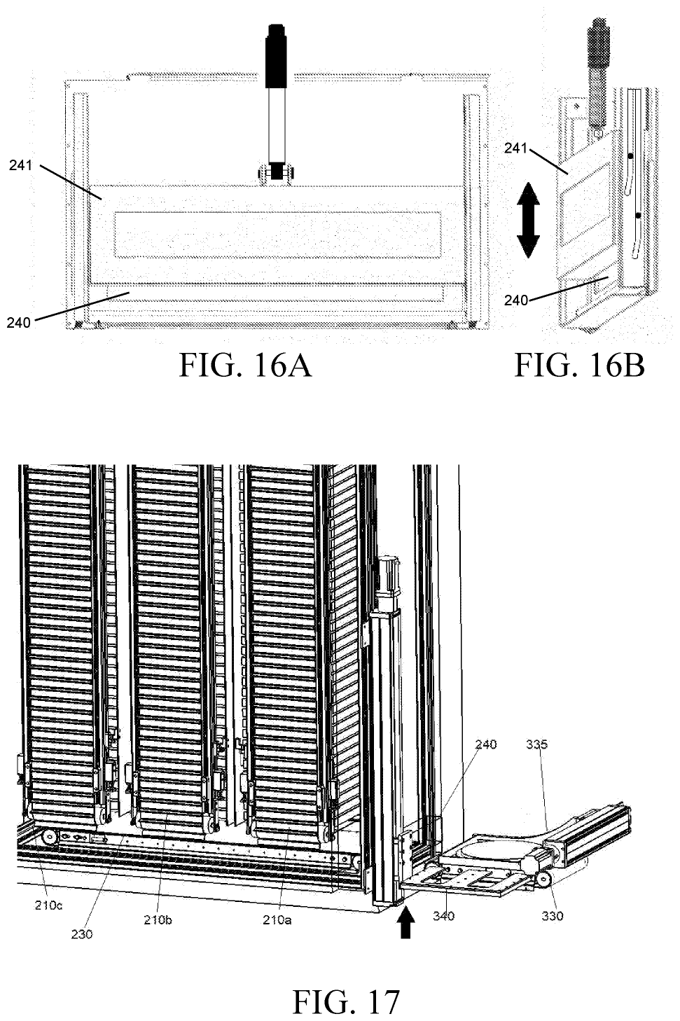

FIG. 16A and FIG. 16B show an exemplary insulated, motorized hatch cover 241 in a semi-open position over the hatch 240.

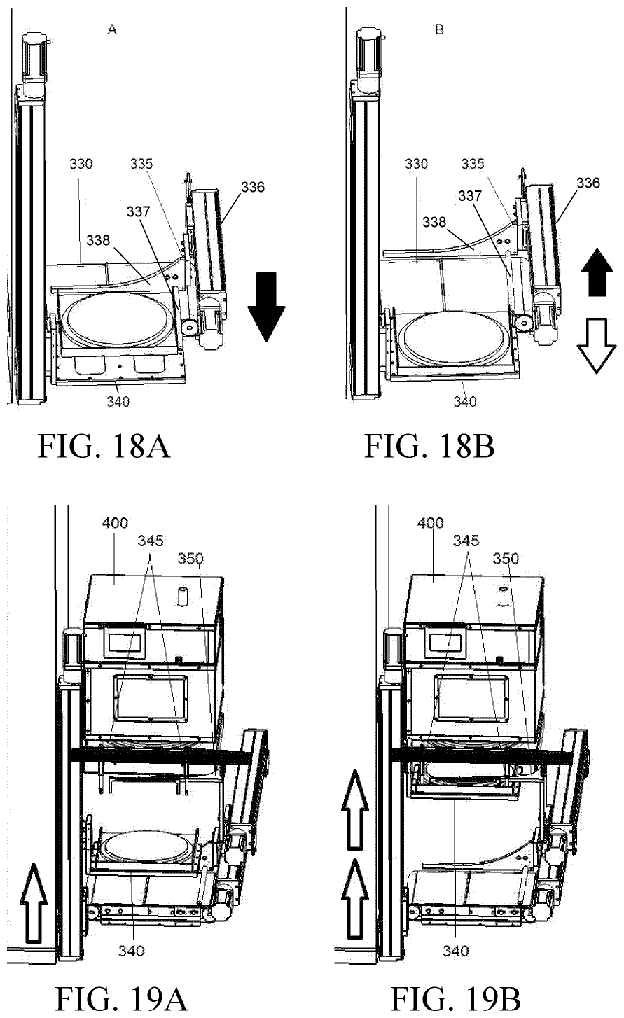

FIG. 17 shows an exemplary oven-side conveyor 330 with a food product/box (i.e., food package). An exemplary sweeper arm assembly 335 has an stopper bar 337 (see FIG. 18A) that is orthogonal to the motion of the oven-side conveyor 330, and aligns the box. The elevator platform 340 has risen (1-2″) to a co-planar position to the oven-side conveyor to receive the box when the sweeper arm assembly 335 pushes the box towards the front of the oven compartment 103.

FIG. 18A and FIG. 18B show the exemplary sweeper arm assembly 335. A sweeper actuator 336 moves the stopper bar 337 and sweeper bar 338. The stopper bar 337 is oriented perpendicular to the direction of travel of the oven-side conveyor 330 and provides a surface for the food product/box to stop against in the event of over-travel. The sweeper bar 338 is oriented parallel with the direction of travel of the oven-side conveyor 330. The sweeper bar 338 sweeps the food product/box off of the oven-side conveyor 330 and onto the elevator platform 340.

FIG. 19A and FIG. 19B show an exemplary elevator assembly, including an elevator actuator which lifts the elevator platform 340 with the food product/box from the bottom of the oven compartment 103 to the oven unit 400. The vertical position of the elevator platform 340 aligns both with the oven unit 400 and also with the delivery chute 106 (see FIG. 1) through which a cooked food product/box is delivered after the food product has been cooked in the oven unit 400. The delivery chute 106 is preferably a comfortable and easily-reachable height above the ground, (between 24″ and 38″).

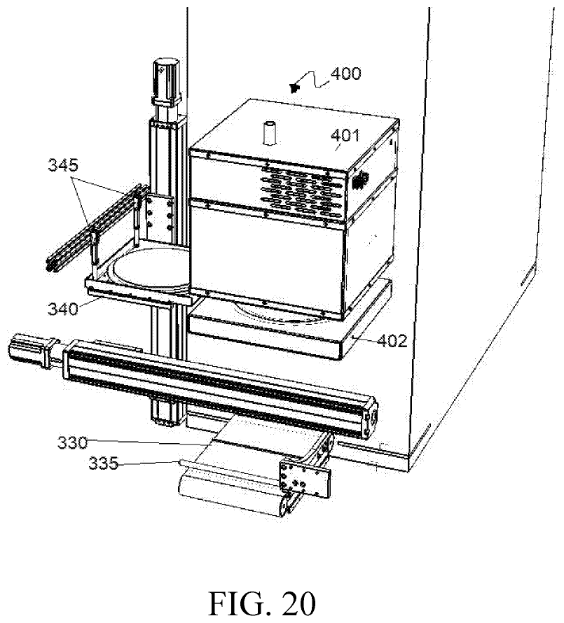

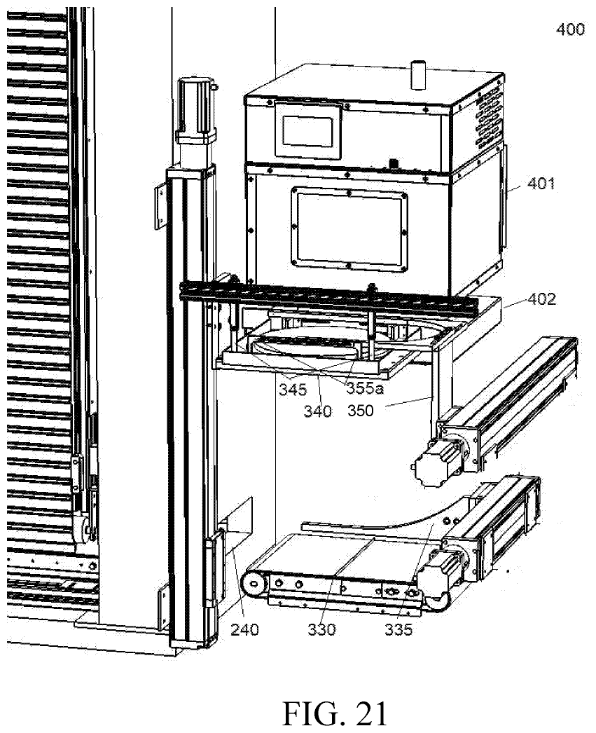

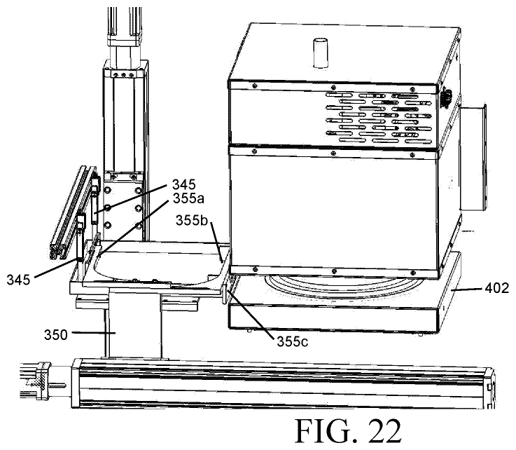

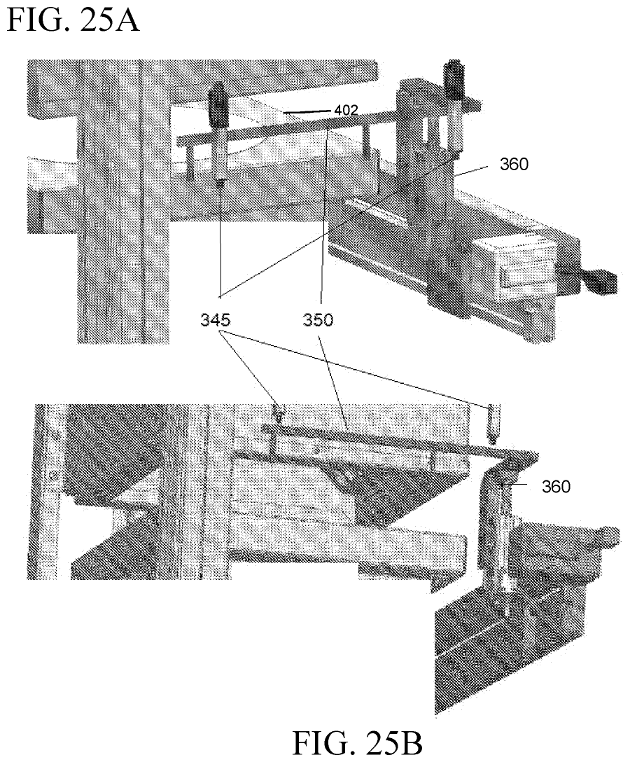

FIG. 20, FIG. 21, FIG. 22, FIG. 25A, and FIG. 25B show the box retention fingers 345, which include finger members that can be retracted and extended by small actuators. When the elevator platform 340 with the food product/box has been raised to a proper height, the box retention fingers 345 extend downward to capture the box and prevent it from sliding.

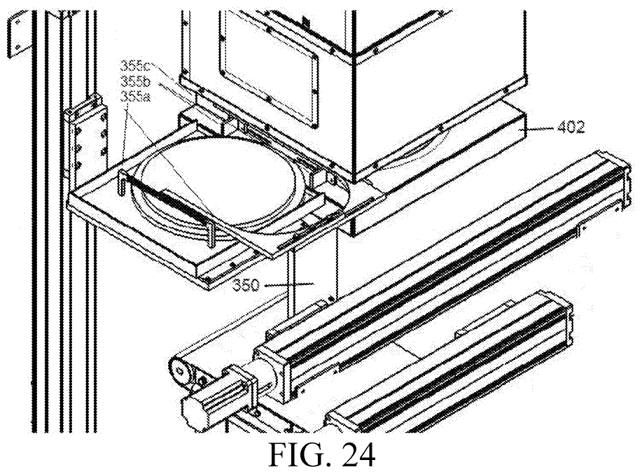

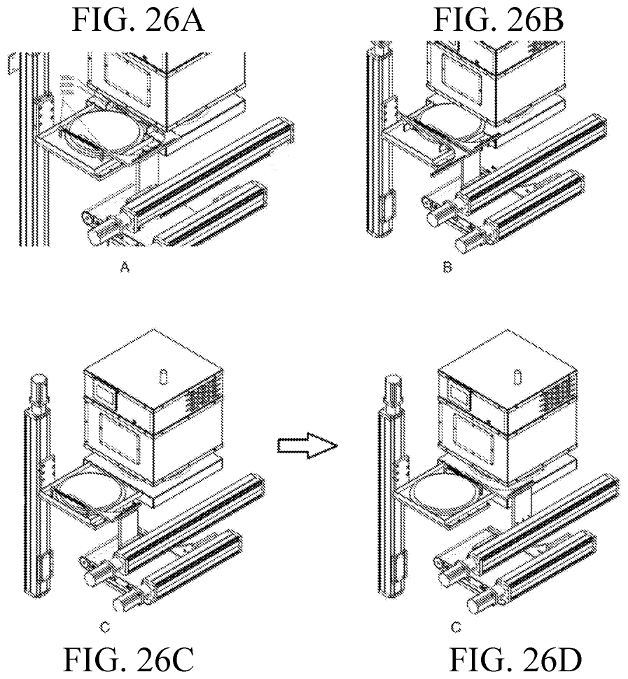

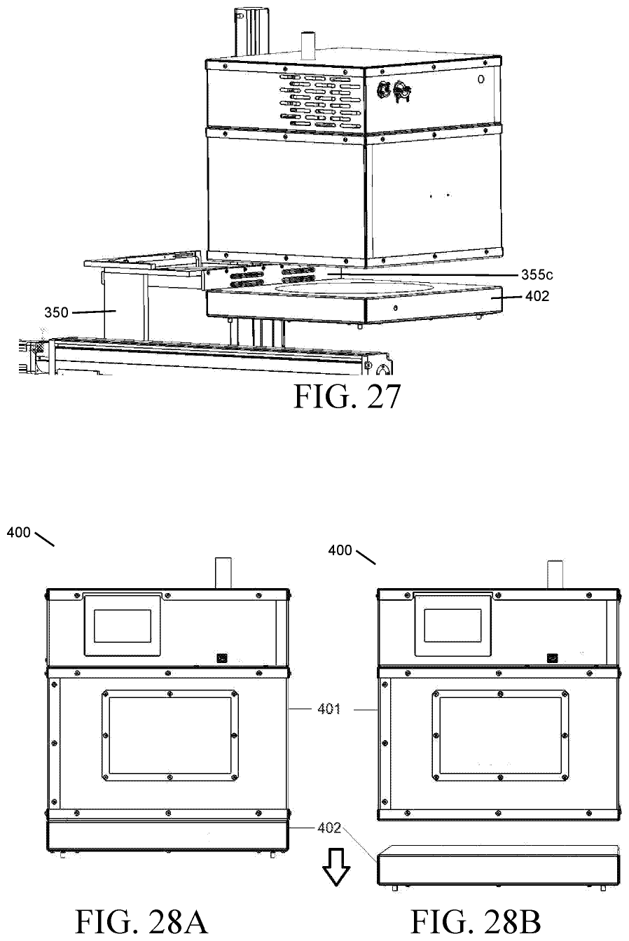

FIG. 21 thru FIG. 24, FIG. 26A thru FIG. 26D, and FIG. 27 show a wrangler (“loading end-effector”) assembly 350 including a front-side member 355a that touches an edge of the food product at two points of contact in order to assist in self-centering of a round food product (e.g., pizza). The wrangler assembly 350 also includes a loading/unloading actuator for causing the front-side member 355a to push the food product out an open front of the box into the oven unit 400.

The transportation mechanism for moving the food product out of the box and back into the box following heating utilizes the wrangler assembly 350. This shepherding device is able to guide the transfer of the food product out of the box and onto a base oven deck 402 of the oven unit 400. Upon completion, a back-side member 355b of the wrangler with an attached optional scraper 355c to clear a surface of the base oven deck 402, will steer the hot food product off the hot base oven deck 402 and onto the unheated box, additionally, clearing the clearing the surface of the base oven deck 402, and brushing crumbs off the edge of the base oven deck 402 between a gap between the box and the oven, into a crumb tray below, located on the floor of the oven compartment.

The loading/unloading actuator moves the wrangler assembly 350 and is responsible for pushing the food product into the oven unit (from the front), and also for pushing the food product out (from the rear) after cooking.

FIG. 25A and FIG. 25B show an optional motorized lifting module 360. The motorized lifting module 360 raises the wrangler assembly 350 just enough (1.2″) to clear the height of the food product as the wrangler moves to and from the rear (i.e., the base oven deck). This actuator may be omitted if cost is a factor, in which case the oven's loading platform drops enough to allow the wrangler assembly 350 to move above the food product on its way to and from the rear.

Once the wrangler assembly 350 has been positioned behind the food product, the loading/unloading actuator moves forward and sweeps the cooked food product back into the box. The box retention fingers 345 then rise via retraction of mini-actuators and release the box, and the loading actuator keeps moving forward, pushing both the cooked food product and box out through the delivery chute 106 (FIG. 1), which is aligned with the oven platform.

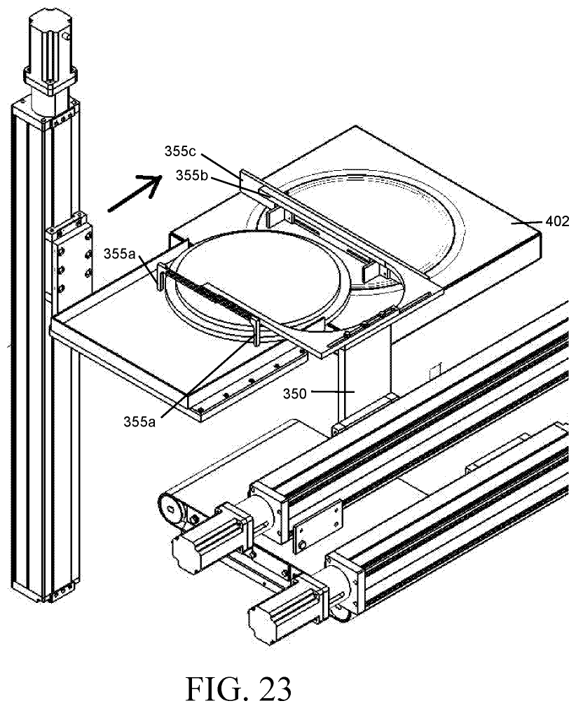

As shown in FIG. 23, the back-side member 355b of the wrangler assembly 350 establishes two points of contact, and their separation is also adjustable to accommodate varying food product (pizza) diameters. They are used to push the food product (pizza) out of the oven unit 400 and back into the box after cooking.

As shown in FIG. 23 and FIG. 27, the scraper 355c is a flat, wide member that is designed to scrape the surface of the base oven deck 402 and dislodge any debris that may have adhered to the surface after a cooking cycle. The bottom surface of the scraper 355c maintains physical contact with the base oven deck 402, dislodging debris as the scraper 355c is swept across the base oven deck 402 during loading and unloading of the food product. A gap (<1″) between the base oven deck 402 and the box provides a place for scraped debris to fall and be collected.

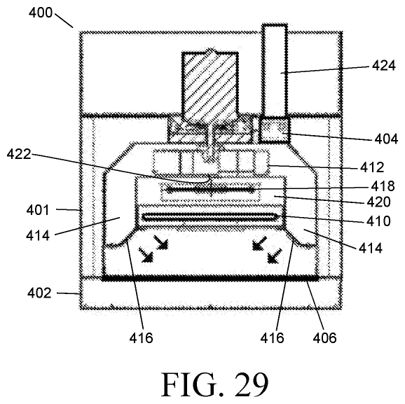

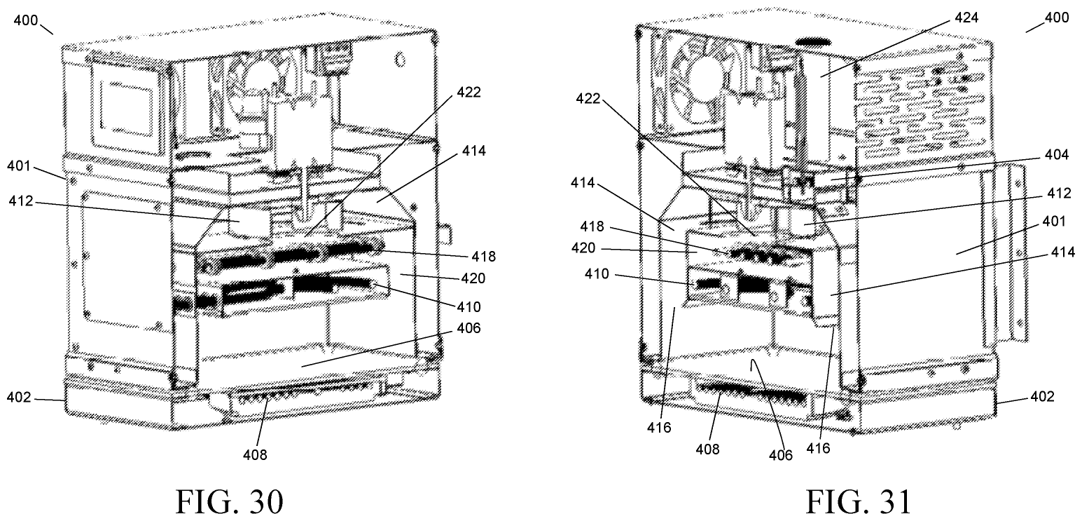

FIG. 28A, FIG. 28B, FIG. 29, FIG. 30, and FIG. 31 show the elements of the oven unit 400 for the preparation of the food product (e.g., pizza) utilizing multiple cooking modes. The specialized “rapid cook” unit features three fundamental heat transfer methods (i.e., heating modes): forced convection air impingement, [Infrared] radiation, and [deck] conduction, NOT using microwave technology. The combination leads to faster preparation of the pizza. The base oven deck 402 [platen] operates as a deck oven; providing a solid surface to support the food product (pizza). The oven unit 400 is comprised of a main body 401 and the base oven deck 402. Both parts are insulated. Furthermore, the oven unit 400 is opened by lowering the base oven deck 402 relative to the main body 401 (i.e., the oven unit 400 does not have a door through which the food product is inserted and removed from the oven unit 400). This open-side down (i.e., inverted can) design retains heat within the oven (hot air rises) even during the insertion and removal of the food product to/from the oven when the entire bottom is completely open.

This design ensures keeping as much heat within the oven as possible during introducing the food product and taking out the food product from the oven. Oven temperature may vary in a range from about 400° F. to about 600° F. based on factors such as time since the previous food product was prepared, frequency of food product orders, and the type of food product currently being prepared, in addition to a preheat time.

The base oven deck 402 includes a heated platen 406 that comes in direct contact with the food product. In a standby mode, as shown in FIG. 28A, the base oven deck 402 is in a raised position in contact with the main body 401. When a food product is ordered, the base oven deck 402 lowers to a position to accept the food product. Once the food product is placed on the base oven deck 402, the base oven deck 402 rises to meet and seal with the main body 401. In one embodiment, the base oven deck 402 is a thin stainless steel “box” with the platen 406 on top. The “box” is fully insulated with ceramic fiber insulation. The platen 406 is heated by an electric heater 408 encased in the base. In one embodiment, the electric heater 408 is a planar arrangement of heating elements (thin round wire or metal ribbon) mounted on a disc of thermal insulation. The low thermal mass of this heater provides almost instantaneous heat up. In one embodiment, the platen 406 is an aluminum material, which reaches cooking temperature quickly because aluminum has a much better thermal conductivity than stainless steel. In another embodiment, the platen 406 is a 5 mm thick sheet of glass ceramic material, such as platinum glass, Neoceram™, Pyroceram™, or Robax®. Such glass ceramics are characterized by high temperature rating (continuous operation up to 1300° F.), high strength and impact resistance, low coefficient of thermal expansion, and good resistance to thermal shock (important when sliding a frozen food product onto the surface). Such glass ceramics both transmit thermal radiation and absorb thermal radiation, leading to heating the food product by both radiation and conduction. Advantageously, the platen 406 made of glass ceramic material cooks and crisps the bottom of the food product (i.e., pizza crust), to create a finished product with a crispy, toasted bottom with exceptional flavor and texture profiles, a result similar to a traditional brick oven.

As shown in FIG. 29, FIG. 30, and FIG. 31, the main body 401 and the base oven deck 402 define an oven cavity where the food product is cooked. The main body 401 includes circular radiant elements 410 and a motor-driven fan 412 that pressurizes a plenum 414 on both sides of the oven cavity. The motor-driven fan 412 is located in the top portion of the main body 401. The plenum 414 feeds opposite sides of the oven cavity to impingement jets 416 that deliver heated air to exposed surfaces of the food product. The heated air is warmed by open coil (i.e., bare wire) heaters 418 located in a return duct 420 just before a return opening 422 to the motor driven fan 412. Bare wire heaters heat up rapidly and efficiently transfer to the air. This forced convection air impingement heating mode heats the environment around the food product (i.e., pizza) and can help moderate the heating effects of the circular radiant elements 410. In one embodiment, the circular radiant elements 410 are quartz heating elements for rapid heat-up, efficient heat transfer, and ability to provide controllable browning to the food product (i.e., pizza). A reflective surface is located approximately 25 mm above the circular radiant elements 410 as well as a reflective surface applied to the top half of the circular radiant elements 410. The reflective surfaces increase the radiant heating efficiency by reflecting radiant energy downward toward the food product. The circular radiant elements 410 reach cooking temperatures in 10 to 15 seconds. The circular radiant elements 410 deliver most of the energy provided to the product in the beginning of the cook cycle. Each of the heating components is controlled individually by an oven controller.

The oven unit 400 includes a vent 424 located in the main body 401 open to the plenum. As air exits the oven unit, it passes through a catalytic converter 404 (e.g., an electrically heated catalyst). The catalytic converter 404 breaks down grease-laden vapors and smoke for ventless operation (i.e., removes undesirable hydrocarbons before they exit the oven unit 400). This allows the food product storage and vending kiosk 100 to be placed indoors without additional venting to the outside, allowing ventless operation.

The working steps of the exemplary food product storage and vending kiosk 100, as described above, are:

A customer orders a food product (e.g., a pizza) with the touchscreen display 107;

If an internal temperature of the oven unit 400 is not sufficient, a preheat cycle on the oven unit 400 begins;

A food product in a box folded as a tray is released from the column (e.g., 201a, 201b, 201c) from within the cold storage unit 101;

The hatch cover 241 opens the hatch 240 from the cold storage unit 101; The transportation mechanism transfers the food product in the box (tray) out of the cold storage unit 101;

The transportation mechanism moves the food product in the box (tray) off the oven-side conveyor 330 and onto the elevator platform 340;

The elevator assembly raises the food product and box (tray) in close proximity to the base oven deck 402;

A pair of box retention fingers 345 secure the box (tray) on the elevator platform 340; The base oven deck 402 lowers to receive the food product; The wrangler assembly 350 pushes the food product out of the box (tray) and onto the base oven deck 402;

The base oven deck 402 rises to close the oven unit 400 and begins the cook cycle, which is less than 180 seconds;

Upon completion of the cook cycle, the oven unit 400 opens by lowering the base oven deck 402 from the oven main body 401;

The food product is taken from the oven unit 400 using the back-side of the wrangler assembly 350 to push the food product off the base oven deck 402 back into the box (tray);

The box retention fingers 345 securing the box (tray) release; and

The food product in the box (tray) is pushed through the delivery chute 106 to the customer.

It will be understood that various details of the presently disclosed subject matter can be changed without departing from the scope of the subject matter disclosed herein. Furthermore, the foregoing description is for the purpose of illustration only, and not for the purpose of limitation.

What is claimed is:

1. A food product storage and vending kiosk comprising:
a cold storage unit including a plurality of food packages, an active shelving system storing the plurality of food packages, and a refrigerator for maintaining an interior of the cold storage unit at a predetermined temperature, each of the food packages including a food product in a box;
an oven unit including a base oven deck for receiving the food product and rising to meet and seal with a main body to form a sealed oven cavity for cooking the food product; and
a transportation mechanism for moving a food package out of the cold storage unit, onto an elevator platform that lifts the food package to the oven unit, pushing the food product from the box directly onto the base oven deck for cooking, and pushing the food product off of the base oven deck into the box and out of a delivery chute of the kiosk after cooking.

2. The food product storage and vending kiosk of claim 1, wherein the box of each of the plurality of food packages has an open top and an open front forming a three-sided tray containing the food product, and wherein the active shelving system includes a plurality of columns of shelf elements supporting and dispensing the plurality of food packages.

3. The food product storage and vending kiosk of claim 2, wherein each of the plurality of columns of shelf elements includes two parallel Archimedes screws and screw actuators, an outer diameter and pitch of each of the Archimedes screws configured such that one of the plurality of food packages is capable of being supported between threads of each of the screws and synchronized rotation of the Archimedes screws by the screw actuators lowers the column until a food package drops free of the column.

4. The food product storage and vending kiosk of claim 2, wherein each of the plurality of columns of shelf elements includes two parallel vertical conveyor belts and belt actuators, with cleats attached to each of the conveyor belts configured such that one of the plurality of food packages is capable of being supported between cleats of each of the conveyor belts and such that synchronized movement of the conveyor belts lowers the column until a food package drops free of the column.

5. The food product storage and vending kiosk of claim 2, wherein each of the columns of shelf elements is mounted on a telescopic rail which allows the respective column of shelf elements to be pulled out by machine maintenance personnel for service access or replenishment of food packages.

6. The food product storage and vending kiosk of claim 1,
wherein the base oven deck includes a heated platen that comes in direct contact with the food product, and
wherein the main body includes circular radiant elements in a center area of the oven cavity, a plenum on both sides of the oven cavity, a motor-driven fan on top of the main body that pressurizes the plenum, a return opening to the motor driven fan, a return duct from the oven cavity to the return opening, open coil heaters in the return duct, and impingement jets fed by the plenum that deliver heated air to exposed surfaces of the food product, such that the oven unit achieves heat transfer by methods of impingement, radiation, and conduction.

7. The food product storage and vending kiosk of claim 6, wherein the main body of the oven unit further includes a vent open to the plenum for exhaust from the oven unit, and an electrically heated catalyst in the vent to remove hydrocarbons in the exhaust.

8. The food product storage and vending kiosk of claim 2,
wherein the cold storage unit defines a hatch between an interior of the cold storage unit and an oven compartment wherein the oven unit is located, and includes a motorized hatch cover over the hatch; and
wherein the transportation mechanism includes a storage unit conveyor below the active shelving system and an oven-side conveyor in alignment with the hatch, the storage unit conveyor and the oven-side conveyor for transporting a food package from the storage unit, through the hatch, and into the oven compartment.

9. A food product storage and vending kiosk comprising:
a cold storage unit including a plurality of food packages, each of the plurality of food packages including a food product in a box;
an oven unit including a main body having an open bottom side oriented down and a base oven deck for receiving the food product and rising to meet and seal with the main body to form a sealed oven cavity for cooking the food product; and
a transportation mechanism including an oven-side conveyor, an elevator platform, and a sweeper arm assembly, wherein
the elevator platform and the sweeper arm assembly are positioned at opposite sides of the oven-side conveyor,
the sweeper arm assembly includes a stopper bar oriented perpendicular to a direction of travel of the oven-side conveyor, a sweeper bar oriented parallel with the direction of travel of the oven-side conveyor, and a sweeper actuator for causing the sweeper bar to sweep the food package off the oven-side conveyor and onto the elevator platform, and
the transportation mechanism is for moving a food package out of the cold storage unit and onto the elevator platform that lifts the food package to the oven unit, pushing the food product from the box directly onto the base oven deck for cooking, and pushing the food product off of the base oven deck into the box and out of the delivery chute after cooking.

10. The food product storage and vending kiosk of claim 9, the transportation mechanism further including a pair of box retention fingers and a wrangler assembly, wherein
the box retention fingers engage the box of the food package when the elevator platform has lifted the food package to the oven unit, and
the wrangler assembly includes a front-side member, a back-side member, and a loading/unloading actuator, the loading/unloading actuator for causing the front-side member to push the food product out the open front of the box onto the base oven deck before cooking and for causing the back-side member to push the food product from the base oven deck back into the box after cooking, and then, after retraction of the box retention fingers, pushing the food product and box out through the delivery chute.

11. The food product storage and vending kiosk of claim 10, wherein the wrangler assembly further includes a motorized lifting module for raising the front-side member and back-side member of the wrangler assembly enough to clear the food product as the loading/unloading actuator moves back to the elevator platform after pushing the food product onto the base oven deck before cooking and back to the base oven deck before pushing the food product back into the box after cooking.

12. The food product storage and vending kiosk of claim 10, wherein the back-side member of the wrangler further includes a scraper to scrape crumbs off a surface of the base oven deck into a gap defined between the base oven deck and the box as the loading/unloading actuator causes the back-side member of the wrangler assembly to push the food product from the base oven deck back into the box after cooking.

13. An oven unit comprising:
a main body and a base oven deck defining an oven cavity, the main body having an open bottom, the base oven deck for receiving a food product and rising to meet and seal with the main body for cooking the food product in the oven cavity, the main body being opened by lowering the base oven deck relative to the main body;
the main body including:
radiant elements directly over the oven cavity for providing radiant heating to the food product; and
impingement jets on respective sides of the oven cavity for providing convection heating the food product; and
the base oven deck including a heated platen for providing conductive heating to a bottom of the food product.

14. The oven unit of claim 13, wherein the main body further includes a reflective surface above the radiant elements, the reflective surface increasing radiant heating efficiency by reflecting radiant energy downward toward the food product.

15. The oven unit of claim 13, wherein the main body further includes:
a motor-driven fan in a top portion of the main body;
a plenum on both sides of the oven cavity between the motor-driven fan and the impingement jets;
a return duct between the oven cavity and the motor-driven fan; and
heaters located in the return duct;
wherein the heaters produce heated air in the return duct, the motor-driven fan pressurizes the plenum with the heated air, the plenum feeds the impingement jets, and the impingement jets deliver heated air to exposed surfaces of the food product.

17. The oven unit of claim 15, wherein the main body further includes a vent between the plenum and an exterior of the main body, the vent including a catalytic converter for removing hydrocarbons before they exit the oven unit, allowing ventless operation of the oven unit in an indoor environment.

18. The oven unit of claim 13,
wherein the heated platen is heated by an electric heater, and
wherein the heated platen is a glass ceramic material, both transmitting thermal radiation and absorbing thermal radiation, such that the bottom of the food product is heated by both radiation and conduction.
